(19) United States
(12) Patent Application Publication
(10) Pub. No.: US 2026/0368182 A1
(43) Pub. Date: Nov. 19, 2026

(54) GENERATIVE ARTIFICIAL INTELLIGENCE (AI) DRIVEN SEARCH OPERATIONS AND OUTPUTS

(71) Applicant: BBY SOLUTIONS, INC., Richfield, MN (US)

(72) Inventors: Rambabu Raipati, Lakeville, MN (US); Kannan Swaminathan, Eden Praire, MN (US)

(21) Appl. No.: 19/212,434

(22) Filed: May 19, 2025

(51) Int. Cl. G06F 16/2457; G06F 16/242

(52) U.S. Cl. CPC G06F 16/2457; G06F 16/2425; G06F 16/243

(57) ABSTRACT

Artificial intelligence (AI) techniques are applied during information retrieval and filtering, including with AI-driven search results and interactions within e-commerce environments. A method for performing refined search assisted by generative content includes: determining a search intent from keyword(s) or phrase(s); generating search results based on the search intent and the keyword(s) or phrase(s); outputting the search results to be presented in a user interface; identifying search refinement options to narrow the search results using at least one artificial intelligence (AI) model, which produces the search refinement options from inputs including (i) the keyword(s) or phrase(s), (ii) the search intent, and (iii) user activity; outputting the search refinement options; receiving selected refinement options; generating narrowed search results based on applying the selected refinement options to the search results; and outputting the narrowed search results to be presented in the user interface.

### TECHNICAL FIELD

Embodiments discussed herein generally relate to artificial intelligence (AI) techniques and information systems, including the use of generative and predictive AI techniques. Certain embodiments discussed herein relate to approaches that enable the integration of generative and predictive AI into user interaction and information search environments.

### BACKGROUND

In typical e-commerce user interfaces, users may search for products or services by providing textual search terms (e.g., keywords or phrases) that will be interpreted by a search engine, and the search engine will return a set of results that match the search terms to be presented back to the customers. Once presented with the results, customers may use search narrowing tools such as facets and filters to narrow down the search results to certain products or services with specific features that they are interested in.

Some search engines also provide the ability for customers to view and add suggested search terms into their search queries, including in scenarios where suggested search terms are generated based on what other customers are searching for, based on historically popular search terms or trending search keywords and phrases. However, in these scenarios, the search terms are human-provided and are subject to widescale changes and variation, or the search terms may not fully encompass an up-to-date product or service listing.

In addition to performing text-based searches, users may also discover different products or services on a site from advertising placements (e.g., a new product placed at the top of a search result), from curated experiences advertised in the user interface (e.g., deals, promotions, and category-based advertisements), or by being referred by friends or advertising direct links to items on the site. However, each of these approaches involves some manual human selection and guidance to present a new product or service to a user.

### BRIEF DESCRIPTION OF THE DRAWINGS

FIG. 1 illustrates scenarios for performing user searches and interactions using generative AI search functionality integrated into an e-commerce content service, according to an example.

FIG. 2 illustrates a workflow for receiving user input, invoking generative search functionality, and capturing user interaction in connection with an e-commerce content service, according to an example.

FIGS. 3A to 3F illustrate screenshots of a mobile device user interface providing interactions with a generative AI search of an e-commerce content service, according to various examples.

FIG. 4 illustrates a screenshot of a personal computer user interface providing interactions with a generative AI search of an e-commerce content service, according to an example.

FIG. 5 illustrates a flowchart of a workflow for presenting generative search results in an e-commerce setting, according to an example.

FIG. 6 illustrates a flowchart of a method for presenting search results in a user interface, according to an example.

FIG. 7 illustrates a simplified data flow schematic for generative search functionality provided in an e-commerce content service, according to an example.

FIG. 8 illustrates a block diagram of a detailed system configuration for providing generative search functionality in an e-commerce content service, according to an example.

FIG. 9 illustrates an operational schematic for providing generative search functionality in an e-commerce content service, according to an example.

FIG. 10 illustrates a flowchart of a workflow for generating refined search results in an e-commerce setting, according to an example.

FIG. 11 illustrates a flowchart of a method for performing a refined search assisted by generative content, according to an example.

FIG. 12 illustrates a block diagram of computing system components for implementing a generative search system, according to an example.

FIG. 13 illustrates a block diagram of operational components of a computing system upon which any one or more of the techniques herein discussed may be executed and implemented.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The examples discussed herein are directed to features and logic of a computer system to improve search capabilities and refine search results, as enhanced with implementations of artificial intelligence (AI). The integration of AI, including the use of generative and predictive AI models, offers an improved approach to overcoming some limitations of keyword and phrase searches. These examples include AI-generated search refinements such as user interface prompts and suggestions that are dynamically tailored to the user's context and preferences, thereby replacing traditional static facets and filters that are applied to search results. The AI-generated search refinements can be used to guide users at multiple points of a search journey, offering dynamic suggestions that are contextually relevant and personalized based on user behavior and preferences. By leveraging AI-generated user interface prompts and suggestions, a search system can deliver more accurate results and personalized user experiences, enhancing content discovery and engagement in a variety of e-commerce and information system lookups. This not only improves the efficiency and accuracy of search results but also enhances user engagement by providing a more interactive and responsive search environment.

One aspect discussed herein includes the use of various data signals and the application of generative and predictive AI capabilities to provide AI-generated user interface prompts as a search refinement in a user interface, including to filter or direct a search session for a particular type of product. In particular, the surfacing of AI-generated user interface prompts during the search session provides a significant benefit over customer-generated or selected search terms and phrases, helping users find what they are looking for more intuitively and accurately. Because the prompts are generated within an AI model, such prompts can be personalized based on a variety of data that is known about the user, based on what similar users are doing, and based on whether the prompts are contextual to the current customer experience. These AI-generated user interface prompts can be used to help a user narrow, expand, or find search results. In particular, the AI-generated user interface prompts can be used to replace traditional facets and filters that are very prevalent in traditional e-commerce search experiences.

In addition to delivering an improved relevance of search results, the following offers an improved approach to surface different combinations of search results (e.g., items such as products and services) through sponsored or dedicated user interface prompts. For example, a particular source of a product (e.g., a computer manufacturer) can sponsor the placement and surfacing of suggested AI-generated user interface prompts, such as surfacing a particular brand of product as a top result in response to a suggested example prompt of “Top-Rated Laptops for Students”. The user interface prompt can be annotated as sponsored by the manufacturer. Then, when the customer selects the “Top-Rated Laptops for Students” prompt to apply the search refinement, this changes the search results to show Top-Rated Laptops from that manufacturer as ranked at the top of the results. In combination with AI-generated user interface prompts, the use of sponsored user interface prompts can lead to significantly higher visibility of specific vendor products and resulting consumer engagement and conversion (e.g., product sales).

As will be understood, the following approaches for search refinement and improvement refer to e-commerce use cases, but rely on a number of technical implementations and technical solutions to address the underlying problems of information search and retrieval. The following approaches reduce the need for static filters and manual adjustments to search results (e.g., often established by human curators) while adding automation to a search process and increasing the accuracy of search results. The approaches can be used to efficiently process large amounts of data, such as a large product catalog of hundreds, thousands, or millions of items, allowing a more precise and narrower set of results to be delivered to a user with less navigation. The approaches can also be used to precisely deliver product attributes and filtering operations without the use of manually created facets or human-curated content. This results in an accompanying improvement in data processing operations, reduction in bandwidth and data computation resources, and related computing system benefits.

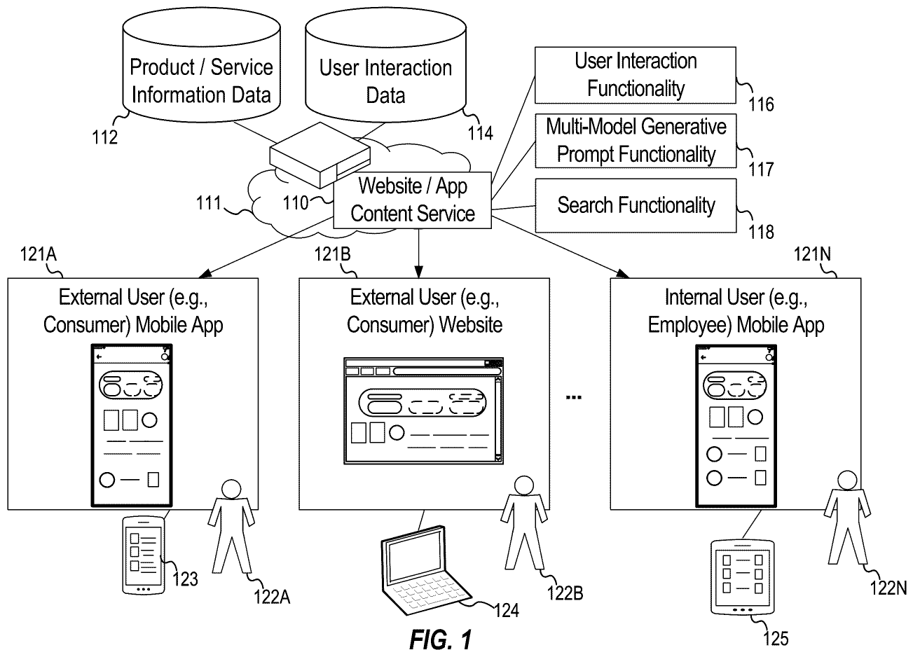

FIG. 1 illustrates example scenarios for performing user searches and interactions using generative AI search functionality integrated into an e-commerce content service. Here, user interfaces 121 to access content from a content service 110 are provided in: a user interface 121A in a consumer mobile application, presented to a consumer 122A via a mobile device 123 (e.g., a smartphone); a user interface 121B in a consumer website, presented to another consumer 122B via a personal computing device 124; and an internal user (e.g., employee) user interface 121N presented to an employee user 122N via a mobile device 125 (e.g., a tablet). A consumer, as discussed herein, is not limited to a single home user or private customer, but may include a variety of entities representing a person, business entity, group, organization, etc. Thus, a user, as discussed herein, may encompass any number of entities that interact with the user interface. Further, a user may also be embodied by an automated agent (e.g., a bot) that acts on behalf of some user or entity.

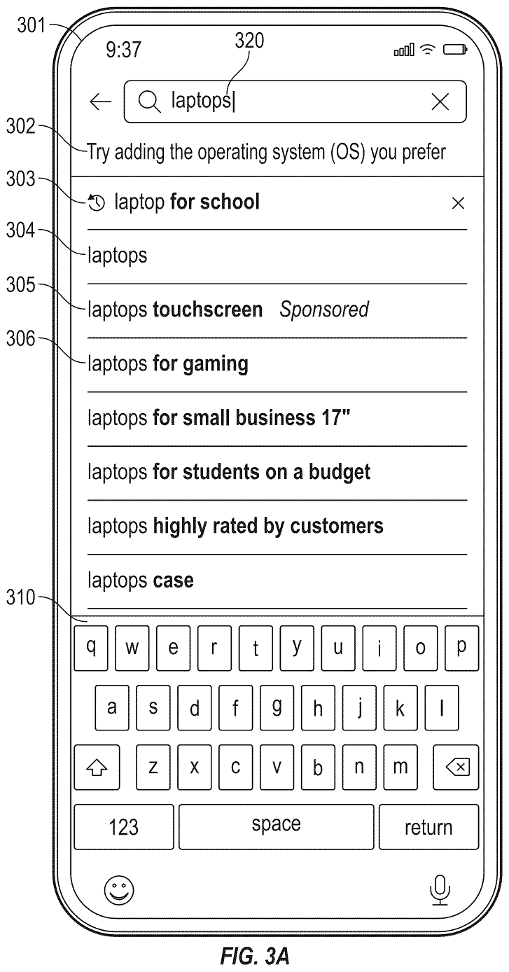

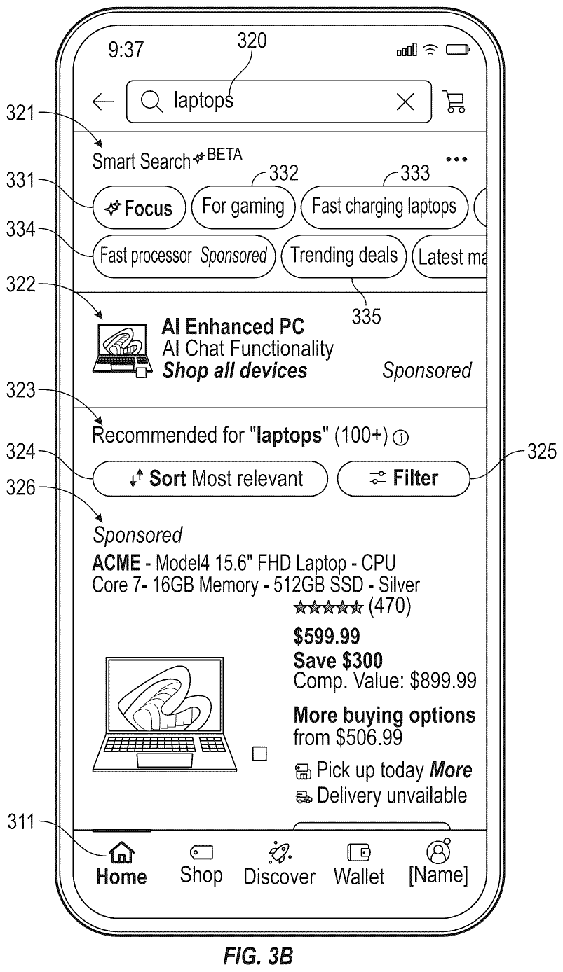

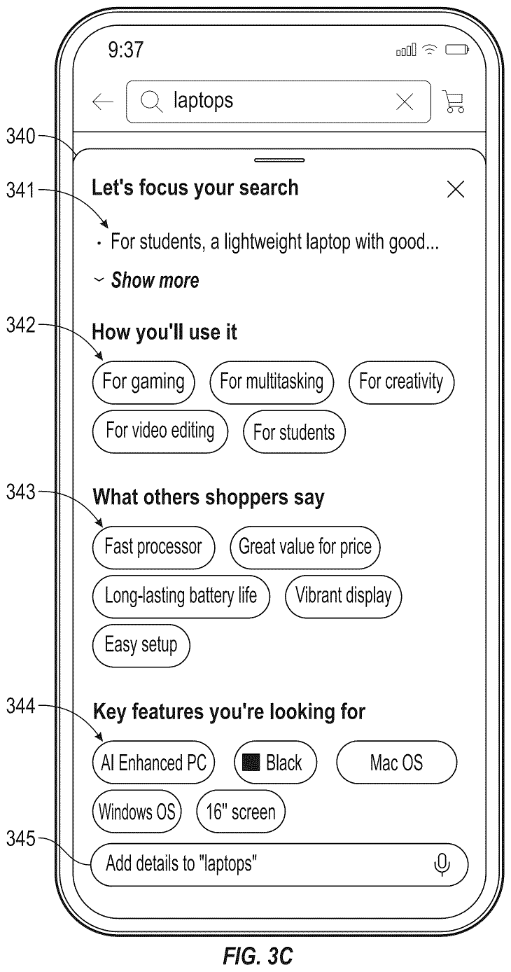

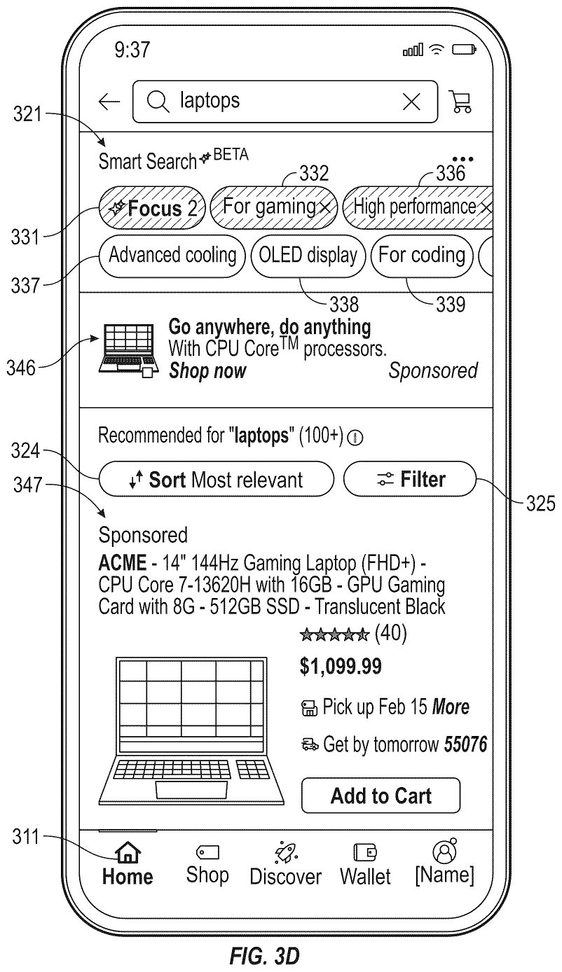

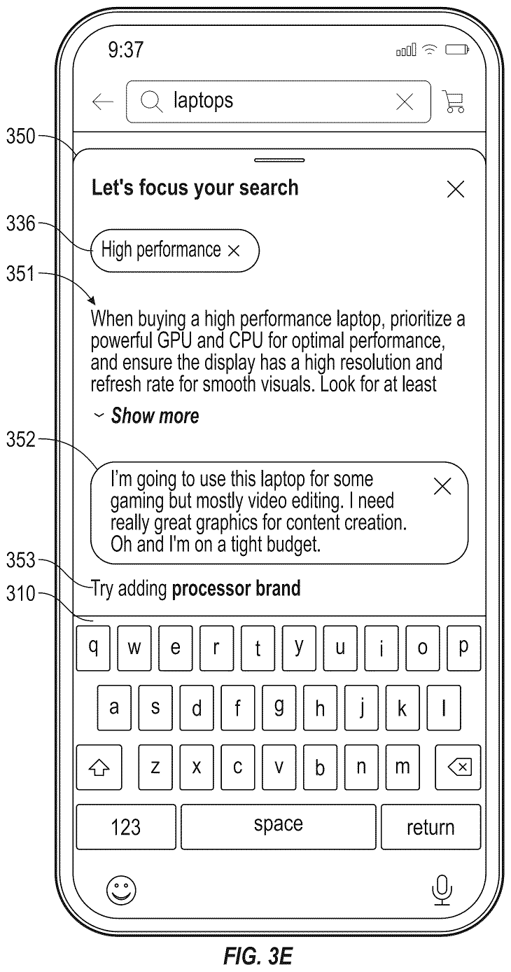

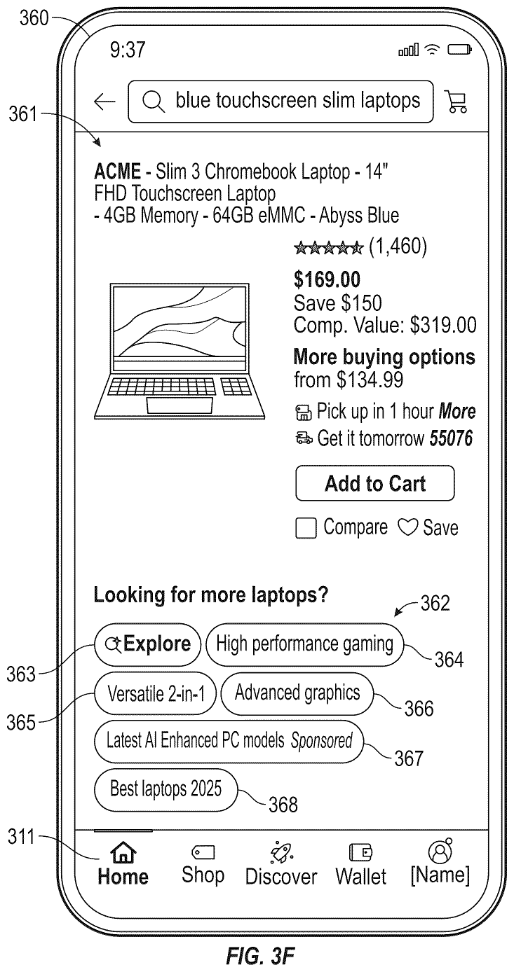

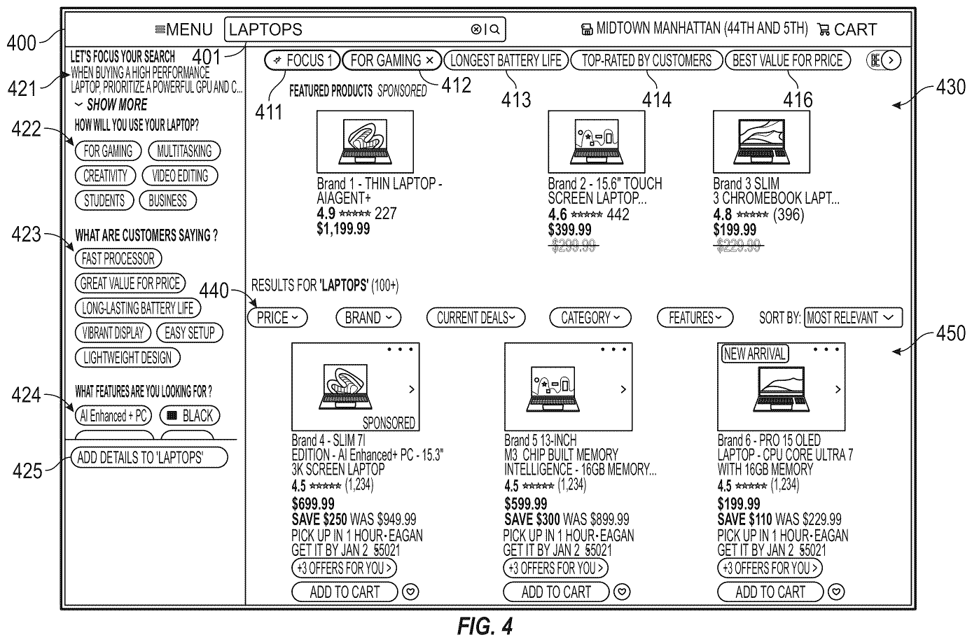

In the scenario of FIG. 1, the consumers 122A, 122B respectively access the content service 110 to obtain e-commerce content in the user interfaces 121A, 121B presented on a computing device (e.g., smartphone, tablet, personal computer). In an example, the user interface 121B is provided from a website operated in a web browser of the personal computing device 124, whereas the user interface 121A is provided from a software app operated on the mobile device 123 (e.g., a software app distributed via an app store). The consumer 122A and consumer 122B each operate the user interfaces 121A, user interface 121B to perform some e-commerce transaction, such as to identify, browse, reserve, purchase, schedule, or otherwise interact with aspects of a particular product or service, including with use of a search tool, search results, and search refinements as discussed herein. Example arrangements of consumer user interfaces in an e-commerce setting are provided in FIG. 3A to FIG. 4 and discussed below. Similar or enhanced functionality may be included in the user interface 121N to perform internal (e.g., employee-only or user-restricted) functions such as inventory checking, reservation, price adjustments and discounts, and the like.

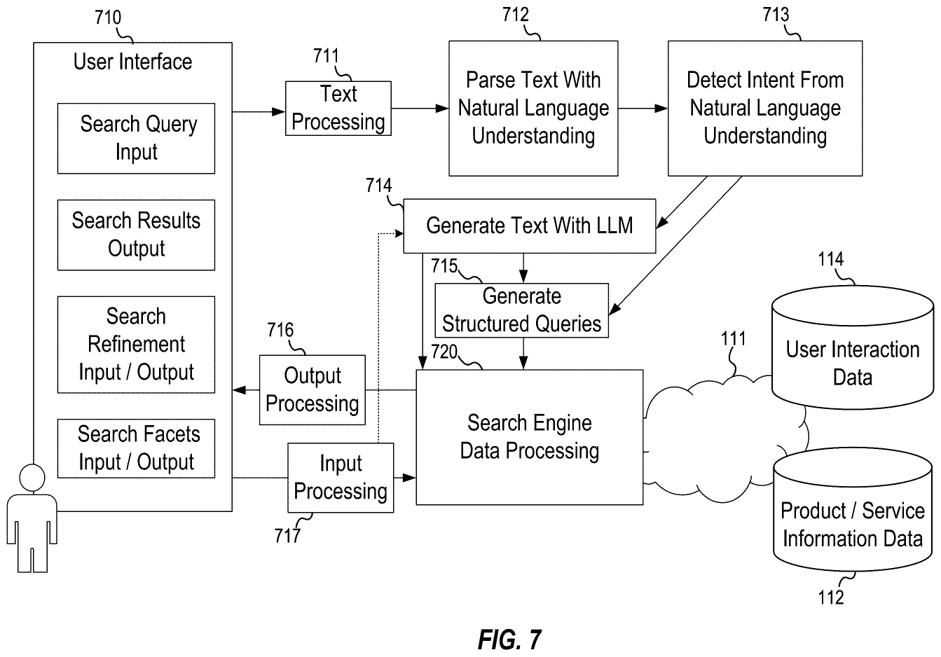

The user interfaces 121 may provide pre-assembled or newly-assembled content from the content service 110, such as content assembled in a cloud service 111 from the product and service information data 112 or user interaction data 114 (e.g., data obtained from one or more data stores, servers, content delivery network (CDN) caches, and the like). The user interfaces 121 may present this data in the form of text, graphics, video, relating to products, services, or other informational content. The data 112, 114 and related information (e.g., product or service details, user profile information, payment information, etc.) may be cached for use by the user interfaces 121. Additional explanations of how the product and service information data 112 and the user interaction data 114 are used by a content service for specific searching use cases are discussed below with reference to FIGS. 7 to 9.

The user interfaces 121 may output content that is hosted, generated, or facilitated by the content service 110 and the cloud service 111, such as content provided by or on behalf of a business entity such as a retailer. For instance, the content service 110 may provide search functionality 118 to present relevant information (e.g., prices, graphics, item descriptions) of one or more commerce items (e.g., products or services), based on searches of the product and service information data 112. The content service 110 may provide user interaction functionality 116 to enable specific transactions and activities (e.g., shopping carts, reservations, shopping lists, checkout, payment) in connection with the commerce items. The content service 110 may provide multi-model generative prompt functionality 117 to assist the searches and the user interactions with the commerce items, based on AI models that evaluate information from the product and service information data 112 and from the user interaction data 114. Example outputs from the multi-model generative prompt functionality 117 are depicted in many of the following figures.

In a conventional e-commerce search, users search for products and services by providing textual search terms (e.g., keywords or phrases) that will be interpreted by a search engine, which returns a set of matching or relevant results to the users. Then, the users might use facets and filters to narrow down the search results to particular characteristics that they are interested in, such as by using facets and filters to limit the search results for a “refrigerator” to only side-by-side models with a built-in icemaker, etc. Users might also employ suggested search terms, based on what other customers are searching for, such as by selecting popular or trending search terms. While many trends may be timely, the use of suggested or curated search terms does not surface all available products and may limit the accuracy or usefulness of search results. As a result, many variations of products and services may not be visible or prominently featured for a particular user. The following AI-generated workflow provides enhanced aspects of delivering AI-generated user interface prompts and content to assist a user with the overall search process, while expanding the availability of content and user functionality when performing searches.

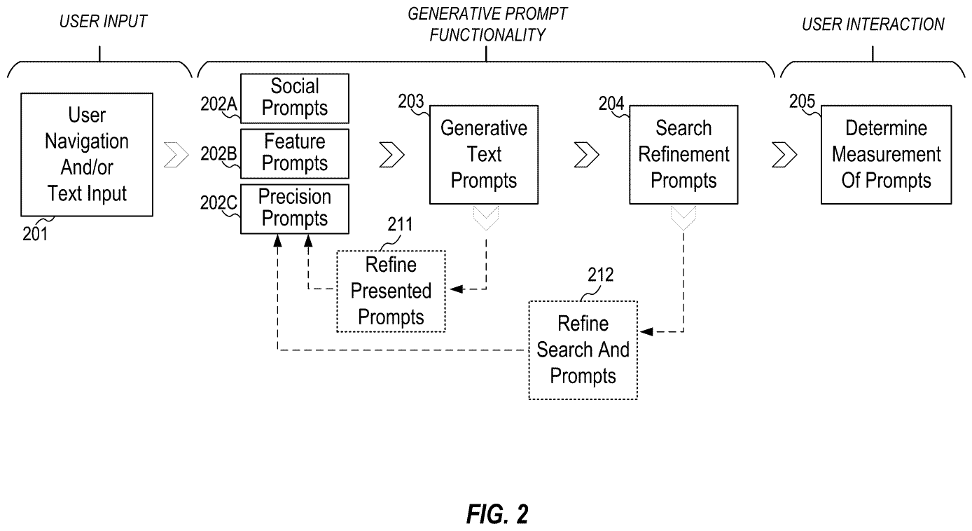

FIG. 2 illustrates an example workflow for receiving user input, invoking generative search functionality, and capturing user interaction in connection with an e-commerce content service. This workflow depicts how user input can be used to generate and refine AI-generated user interface prompts, conduct searches based on these prompts, and measure the effectiveness of the prompts and search results. The workflow begins with user navigation and/or text input 201 in a user interface, such as navigation or inputs provided in the user interfaces 121. This input can be in the form of direct text queries (e.g., keyboard entries of words or phrases into text boxes or input fields) or navigational actions within the user interface (e.g., clicking on a keyword or category name).

Upon receiving the user navigation and/or user text input, the workflow produces various types of AI-generated user interface prompts based on the input, including social prompts 202A, feature prompts 202B, and precision prompts 202C. As used herein, such “user interface prompts” refer to suggested search aspects, generated from one or more AI models, that are presented to the user in a user interface to refine a search or information retrieval activity. These user interface prompts are different than the human-readable directives or instructions that might be input into an AI model such as a large language model (LLM). These user interface prompts, in many examples, present search suggestions generated by AI that clarify the intent of a search and/or guide a user to perform a search with detailed long form keywords and phrases.

Social prompts 202A are derived from user interactions and trends, reflecting popular or highly rated features based on collective user behavior such as user reviews and ratings, popular purchases, etc. An example set of the social prompts 202A is shown with user interface prompts 343 depicted in FIG. 3C, discussed below. Feature prompts 202B provide a listing of featured uses or characteristics of product use cases, such as general features identified from curated product reviews, product descriptions, and AI-generated summaries. An example set of the feature prompts 202B is shown with user interface prompts 342 depicted in FIG. 3C, discussed below. Precision prompts 202C can be used to narrow search results by focusing a search on specific criteria or attributes that distinguish an item in a product category or product type, such as specific characteristics or features of the product that are identified from technical specifications and product descriptions. An example set of the precision prompts 202C is shown with user interface prompts 344 depicted in FIG. 3C, discussed below.

The workflow can also produce other types of AI-generated prompts such as generative text prompts 203. The generative text prompts 203 can enhance the search experience by providing contextually relevant suggestions, instructions, or other information that aligns with inferred user intent or observed user activity. For instance, the generative text prompts 203 can provide detailed explanatory information about the search results or product features, as shown in the example of FIG. 3E, discussed below.

The workflow can also produce search refinement prompts 204 to further tailor or change the search results. The search refinement prompts 204 can provide alternative suggested search terms and expanded search queries, as shown in the examples of FIG. 3A, FIG. 3C, and FIG. 3E, discussed below. The search refinement prompts 204 can be selected to update the search parameters or search query and provide updated and personalized search results.

Additionally, the workflow can provide mechanisms for search changes and refinement, such as refining presented prompts 211 and refining search and suggested prompts 212. For example, in response to the generative text prompts 203 and related user actions (e.g., to enter narrative text in a text entry 352 as shown in FIG. 3E), additional or different types of selectable prompts 202A, 202B, 202C can be presented. Likewise, in response to the selection of suggested search refinement prompts 204, additional or different types of the selectable prompts 202A, 202B, 202C can be presented. Overall, adjustments can be made in response to additional user navigation and input, in some examples with an iterative loop.

The workflow concludes with a measurement 205 of user interaction with the user interface prompts and resulting search results. The measurements can involve evaluating the effectiveness of the prompts in terms of user engagement and conversion rates, and other interactions occurring in connection with an electronic commerce transaction. The workflow, for example, can track which generated prompt(s) led to successful interactions and transactions, and use feedback and training to improve the underlying AI models and the prompt generation process.

FIGS. 3A to 3F illustrate example screenshots of a mobile device user interface (e.g., smartphone app) providing interactions with generative AI search functionality of an e-commerce content service. FIG. 4 illustrates an example screenshot of a corresponding personal computer user interface (e.g., website user interface) providing interactions with the generative AI search functionality. Other types of user interface formats and layouts may be used.

First, FIG. 3A depicts an example smartphone user interface 301 including functionality that presents the generative text prompts 203 and the search refinement prompts 204. At the top of the user interface 301, a search bar 320 is presented where users can input a search query. In this instance, the user has entered the keyword “laptops” to initiate the search process. A keyboard 310 provided by the smartphone is presented at the bottom of the user interface 301, enabling users to edit and input text directly into the search bar 320.

Below the search bar 320, a suggestion prompt 302 displays AI-generated text, offering personalized guidance to the user regarding the search query. The suggestion prompt 302 suggests adding the user's operating system preference (e.g., Mac® or Windows®) to refine the search for the laptop. The suggestion prompt 302 may be displayed with animation to present a series of suggested tips or instructions for improving the search query.

The user interface 301 also presents a list of suggested search queries including suggestions 304, 305, 306, that are fully or partly AI-generated. The first search suggestion 304 may include the same or auto-completed text being entered in the search bar 320. The second search suggestion 305 may include a sponsored prompt, such as a user interface prompt for touchscreen laptops that presents a list of sponsored products from a particular manufacturer. The third search suggestion 306 may include a generated prompt relevant to a particular use case such as gaming. The user interface 301 also presents historical search queries such as query 303, showing that the user previously selected or entered a search for “laptop for school”. Other search queries (not labeled) may be based on a combination of suggested, predicted, and AI-generated content.

In specific examples, sponsored user interface prompts may be designated by advertising partners such as product manufacturers, service providers, industry groups, and the like. The generation and selection of the sponsored prompt may occur as a direct result of AI-generated content or as an accompaniment to AI-generated content (e.g., such as based on sponsorship of particular related keywords, terms, or phrases). The use of sponsored user interface prompts may be monetized in scenarios where product or service sellers purchase exclusive rights to prompts that direct end users (product or service customers) directly to a group of one or more sponsored products (e.g., “Best laptops for college”). As will be understood, various controls can be placed to limit how many brands, products, or services can appear in a set of sponsored prompts at the same time. Any user interaction with the sponsored prompts can be tracked and managed in a similar manner to other advertising campaigns and the use of advertising technologies.

Next, FIG. 3B depicts a variation of the user interface 301, where the search for the term “laptops” is performed, and a limited set of search results (e.g., up to 100 results) are displayed. The user interface in FIG. 3B is depicted as including a navigation bar 311, search prompt section 321, sponsored content section 322, and search results section 323. Other sections may be substituted or added to the user interface.

The search prompt section 321 depicts multiple selectable prompts, which may include any combination of social, feature, or precision prompts. The search prompt section 321 includes a focus selection 331 (e.g., button) that allows AI-generated prompts to be applied and un-applied to the search results. The search prompt section 321 also depicts selectable feature prompts, including a “For gaming” selection 332, a “Fast charging laptops” selection 333, a “Fast processor” selection 334, a “Trending deals” selection 335, and so on. The “Fast processor” selection 334 is designated as “Sponsored”, and the activation of this selection will show search results from a particular brand or manufacturer associated with the sponsorship.

The search results section 323 depicts search results that may be navigated by scrolling or paging in the user interface. A top search result 326 is designated as a “sponsored” result and has a ranking applied to appear at an earlier position (e.g., first position) in the search results. The search results section 323 may include conventional search result tools such as a sorting selection 324 or a filtering selection 325. The application of the search prompts (e.g., user-selected prompts from search prompt section 321) and the search result tools (e.g., user-selected searching restrictions applied from the sorting selection 324 or the filtering selection 325) may be combined at the same time.

Next, FIG. 3C depicts another variation of the user interface 301, where the search for the term “laptops” is used to provide a focused list of AI-generated prompts in a prompt selection interface 340. This screen may be presented by the user activation of the focus selection 331 (e.g., depicted in FIG. 3B). Here, the prompt selection interface 340 includes a first section with generative text prompts 341, a second section with feature prompts 342, a third section with social prompts 343, a fourth section with precision prompts 344, and a text entry box 345 for entry of input such as additional user refinement text applicable to the search. The user interface prompts presented in the prompt selection interface 340 may be updated in real-time or at a later time based on the additional user refinement text.

Next, FIG. 3D depicts another variation of the user interface 301, similar to FIG. 3B, but showing how the search results for the term “laptop” have been refined based on applying multiple focused search refinements. Here, in the search prompt section 321, the focus selection 331 is selected, and two search refinements are applied: selection 332 (“For gaming”) and selection 336 (“High performance”). Other refinement options, such as selection 337 (“Advanced cooling”), selection 338 (“OLED display”), selection 339 (“For coding”), and the like are not selected. Based on the applied refinement options, a sponsored content section 346 and a search results section 347 are updated to present different content. In the search results section 347, a laptop that is more suitable for gaming uses, e.g., with high performance features, appears at the top of the search results.

Next, FIG. 3E depicts another variation of the user interface 301, providing a search refinement interface 350 where the search for the term “laptop” can be updated based on a combination of narrative text content and selected refinement options. Here, only the refinement selection 336 (“High performance”) is selected. Based on this refinement selection, a text narrative 351 is generated and presented with explanatory content. For example, this text narrative 351 provides information on high performance characteristics that are relevant to the search query.

Additionally, a text entry 352 is presented in the search refinement interface 350 to allow the user to write freeform, unstructured text, such as additional contextual information relevant to the use of a product or service. For instance, this may include additional information about in what ways the user needs “high performance”, and how the laptop might be used. This freeform, unstructured text can be parsed by an AI model to determine changes to the search query. Additional generative content such as a suggestion prompt 353 also can be presented.

Next, FIG. 3F depicts another variation of a user interface 360, where a detailed product search has been performed. In this example, the user has input a detailed search query of “blue touchscreen slim laptops”, which significantly narrows the search results 361. Although a limited number of results may be provided, search refinements 362 may be used to expand or change the search query. For example, the search refinements 362 may be used to direct the user to explore other types of products or product features as toggled by an explore selection 363 (e.g., button). This may include a first search refinement selection 364 to expand the search query (e.g., to include high performance gaming laptops), a second search refinement selection 365 to expand the search query (e.g., to include 2-in-1 laptops), or a third search refinement selection 366 to narrow the search query (e.g., to include only laptops with advanced graphics). The search refinements may also include sponsored refinements, such as a sponsored refinement selection 367 offering a particular feature associated with some brand or manufacturer. Other search refinements such as a social refinement selection 368 may also be presented to allow the selection of new products with high ratings.

FIG. 4 illustrates an example screenshot of a website user interface 400, such as an interface provided in a web browser, providing interactions with a generative AI search of an e-commerce content service. Similar to the discussion of the user interface 301 provided above, the website user interface 400 includes a search bar 401 that enables a search keyword to be entered and changed. The website user interface provides a search results section 450 to display matching results of the search query and a featured products section 430 to display sponsored or featured products relevant to the search query.

The website user interface 400 presents multiple feature prompts 422, social prompts 423, precision prompts 424, and a search refinement entry 425. In addition to presenting these user interface prompts in a dedicated area of the user interface, the website user interface 400 also presents selected prompts above the search results. For example, a focus selection 411 (e.g., button) can allow a selected list of user interface prompts to be activated or de-activated for the featured products section 430 and the search results section 450. As shown, the selected user interface prompts include a first search refinement selection 412 (e.g., “For Gaming”), a second search refinement selection 413 (e.g., “Longest Battery Life”), a third search refinement selection 414 (e.g., “Top-Rated by Customers”), and a fourth search refinement selection 416 (e.g., “Best Value for Price”). Additional search filters and sorting tools 440 may be provided in the website user interface 400 and applied to the search results section 450.

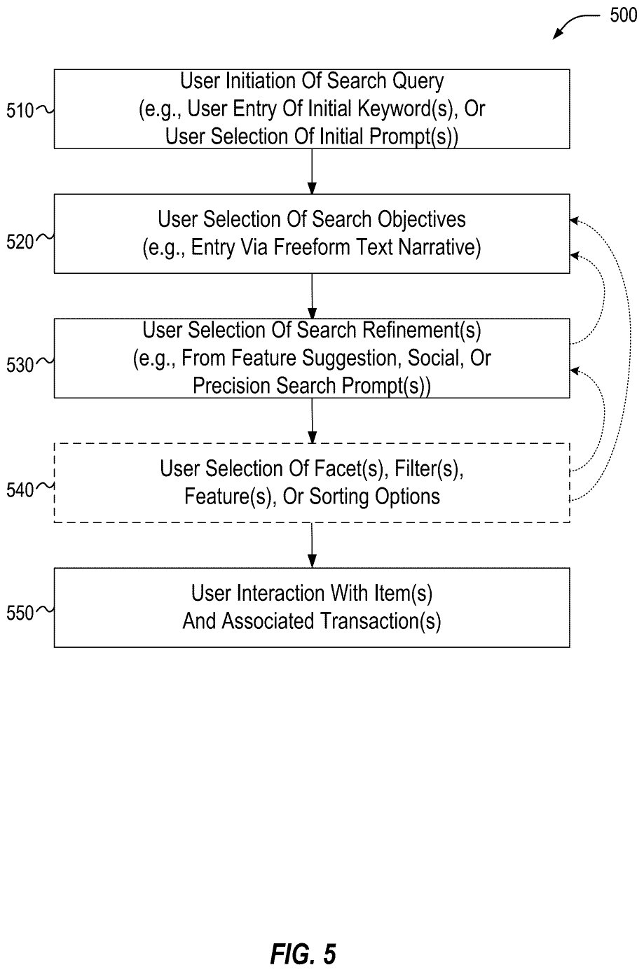

FIG. 5 illustrates a flowchart 500 of an example workflow for presenting generative search results. For instance, the flowchart 500 can be implemented by a computing system to enhance or control the user interface functionality presented above in user interfaces 301, 360, and 400. The flowchart 500 specifically outlines a sequence of operations that guide the user from initiating a search query (operation 510) to interacting with items (operation 550) and completing associated transactions, while applying search refinements and options to interact with the search query results.

At operation 510, the user initiates a search query. This initiation can occur through the entry of initial keyword(s) or phrase(s) in a user interface, or by selecting an initial prompt provided in the user interface. At operation 520, the user selects one or more search objectives. This selection can be made through the entry of a freeform text narrative, or based on a selected user history or selected type of product, allowing the user to specify detailed or nuanced search goals or objectives to find particular items.

At operation 530, the user selects search refinements. These refinements can be chosen from feature suggestion prompts, social prompts, or precision search prompts, as discussed above. The search refinements can be selected to narrow, expand, or change the search results based on specific criteria or objectives. The search query and search objectives can be updated based on the specific combination of search refinements that are selected to be applied.

At operation 540, the user can optionally select applicable options such as one or more facet(s), filter(s), feature(s), or sorting options to be applied to the search results. This optional step provides additional tools for the user to further limit, change, or refine the presentation of the search results in the user interface. In some examples, the applied facets, filters, features, or sorting options can influence the available search refinements and search objectives.

At operation 550, the user interacts with the items and completes associated transactions. This operation can include the user engaging with the search results in the user interface, such as by viewing, selecting, or purchasing items. The user interactions can be tracked and analyzed, as discussed in more details below.

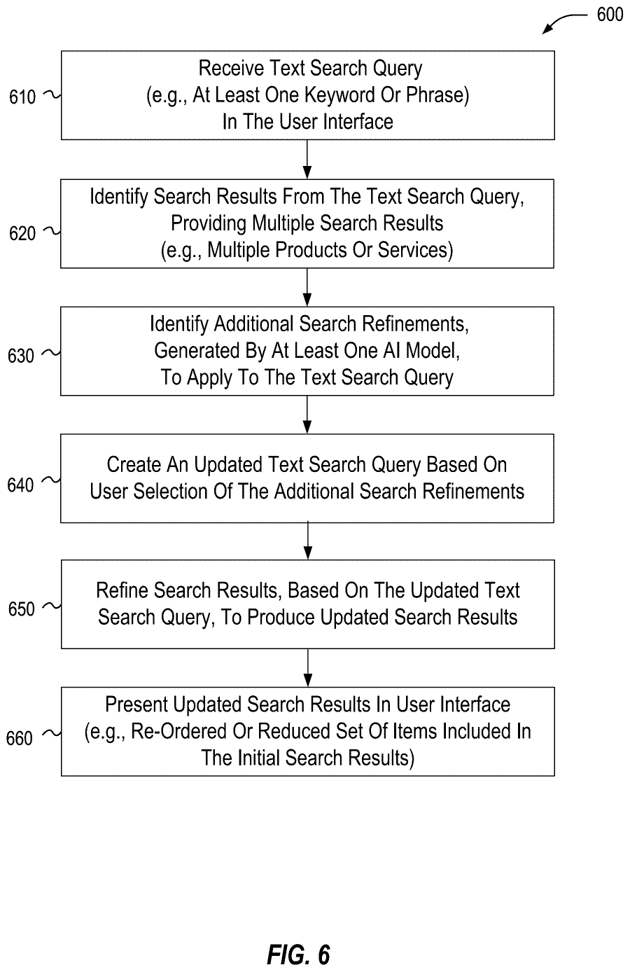

FIG. 6 illustrates a flowchart 600 of an example method for presenting search results in a user interface. This method may be performed by the content service 110 discussed above, or similar services or functionality to operate search and content services for a user interface.

Operation 610 includes receiving a search query in the user interface. For instance, the search query may be provided from user text input, and typically includes at least one keyword or phrase entered by the user.

Operation 620 includes identifying search results from the search query. This includes analyzing the received search query to identify multiple search results, which may include selecting multiple items such as products or services that match the keyword(s), phrase(s) or concept(s) from the search query.

Operation 630 includes identifying additional search refinements capable of being selectively applied to the search results. In an example, at least one AI model is used to generate the additional search refinements that can be selectively applied. For instance, an AI model can analyze various data signals, including user behavior and preferences, to generate refinements such as feature suggestion prompts, social prompts, and precision search prompts. These additional search refinements can be presented in the user interface, where a user selection of one or more of the search refinements can be provided.

Operation 640 includes creating an updated search query, based on user selection of the additional search refinements, to refine and change the results from the initial search query. This operation considers the user's interaction with the suggested refinements, to create an updated search query that reflects the user's preferences and intent to refine the search. The updated search query is structured to incorporate the selected refinements, ensuring that the search results are tailored to the user's search intent.

Operation 650 includes refining the search results, by using the updated search query to produce refined search results. This operation may include applying the updated query to the initial set of search results, filtering the results, and reordering the results based on the user's selections. By refining the search results, the system can remove or re-order irrelevant options and surface results that most closely align with the user's search intent.

Operation 660 includes presenting updated search results in a user interface, where the refined search results are displayed to the user. This operation includes presenting the updated search results in a user-friendly manner, allowing users to view a re-ordered or reduced set of items included in the initial search results.

Additional operations (not depicted in FIG. 6) may include generating and applying search refinements based on narrative text entered in the user interface, such as where the at least one AI model evaluates the narrative text to determine relevance to the items included in the search results. Likewise, the additional search refinements may include search query suggestions generated by the at least one AI model, where such search query suggestions are presented in the user interface based in part on user interactions with the multiple items.

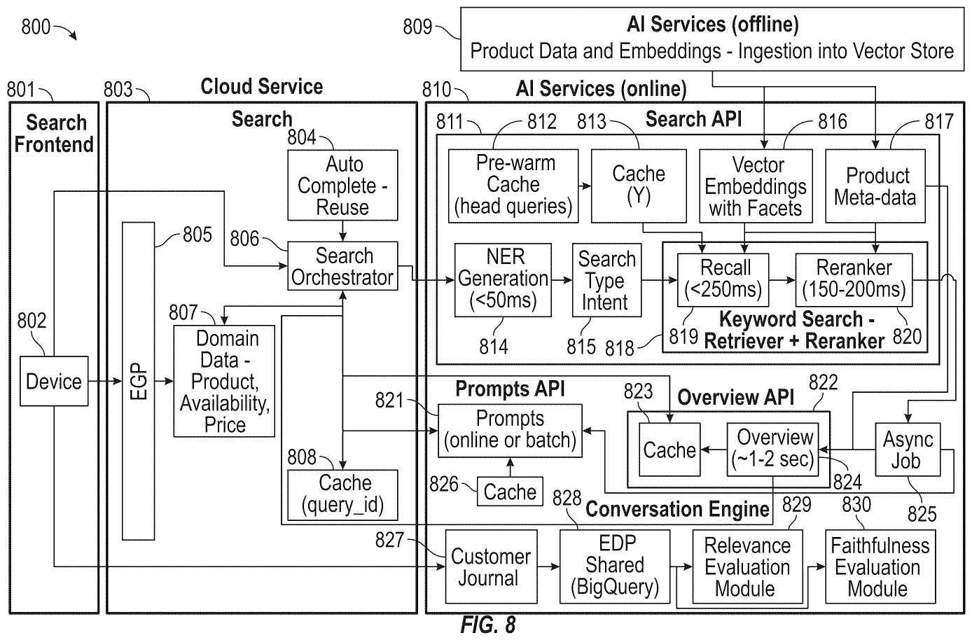

FIG. 7 illustrates a simplified data flow schematic for generative search functionality provided in an example e-commerce content service. This search functionality may be provided consistent with the inputs and outputs discussed above for the user interfaces of FIG. 3A to FIG. 4. Detailed data flows and architectural details used in example search operations with the commerce content service follow in FIG. 8 to FIG. 11.

Returning to FIG. 7, an instance of the user interface 710 provides input and output functionality to implement generative search and generative search refinement, including: search query input, search results output, search refinement input and output, and search facets input and output. The user interface 710, for instance, may enable the user selection operations discussed above in FIG. 5.

The search query input entered by the user can be provided for initial text processing 711, which provides text to be parsed with natural language understanding 712. Relevant search query characteristics such as search intent can be detected from the natural language understanding 713.

The text and the search intent are used to generate additional text with an LLM 714, and to generate structured search queries 715 as expanded by the additional text. The generative text and these structured search queries are provided to the search engine data processing 720. The search engine data processing 720 utilizes the cloud service 111 and the accompanying product and service information data 112 and user interaction data 114 to perform searches and produce search results.

The search results produced by the search engine data processing 720 can provide outputs 716 to be presented in the user interface 710, including the presentation of the search results, selectable search refinements, and selectable search facets. Inputs 717 such as selection, de-selection, and other interaction with the search refinements and the search facets can be provided back to the search engine data processing 720 to facilitate updated and refined searches.

FIG. 8 illustrates a block diagram of a detailed system configuration 800 for providing generative search functionality in an example e-commerce content service. This detailed system configuration 800 is divided into a search frontend 801 (e.g., provided by the user interfaces discussed above, as operated on a user device 802), a cloud service 803, and AI services systems 809 and 810. Other system architectures may be used to implement the presently described search functionality.

The search frontend 801 serves as an initial interface for user interaction with the generative search system. The search frontend 801 is responsible for capturing user inputs, such as search queries (e.g., keywords or phrases), and transmitting these inputs to the underlying components for processing. For instance, the search frontend 801 may be activated by a user device 802, which can be any user-operated hardware, such as a smartphone, tablet, or computer, facilitating the entry of search queries and the display of search results.

The cloud service 803 provides an infrastructure to support search operations and deliver search content back to the user device 802. The cloud service 803 is depicted as hosting various components, including an EGP 805 (a data orchestration platform that uses Graph QL), a search orchestrator 806, a search auto-complete function 804, a domain data function 807, and a cache 808. The cloud service 803 manages data flow between the frontend and backend components, ensuring user queries are processed efficiently and relevant results are retrieved. The cloud service 803 may use distributed computing resources to handle large volumes of data and complex processing operations, providing scalability and reliability to the generative search system.

The offline AI services system 809 can operate ahead of time (before a user search operation) to process product data and embeddings, ingesting these into a vector store for efficient retrieval. This system can operate independently of real-time user interactions by preparing and organizing data for use by the online AI services. The online AI services system 810 offers real-time processing capabilities, utilizing AI models to generate search refinements and suggestions in response to specific user queries.

The online AI services system 810 operates a search API 811 to apply AI-driven logic to user queries. The search API 811 includes cache functionality, including a pre-warm cache 812 and an expanded cache 813 to pre-load frequently accessed queries into cache memory and to assist a recall function 819 and ranking function 820 of a keyword search function. The keyword search function receives search inputs from the cloud service 803 and performs named entity recognition 814 (NER) operations and search type intent analysis 815 on the search inputs, to determine relevant keyword terms for searching. The keyword search function may utilize the caches, vector embeddings 816, and product metadata 817 to perform search queries and rank search results using the keyword terms.

The online AI services system 810 also operates a prompts API 821 and an overview API 822. The prompts API 821 may include a cache 826 for the prompt search refinements, and the overview API 822 may include a corresponding cache 823 for overview content functions 824. An asynchronous job 825 may be used to generate the user interface prompts or the overview content.

The online AI services system 810 also operates a conversation engine including components such as a customer journal 827, an enterprise data platform 828, relevance evaluation functions 829, and faithfulness evaluation functions 830. The conversation engine can track and store various customer actions and perform relevance evaluations and faithfulness evaluations to determine if the search queries and search refinements were successful.

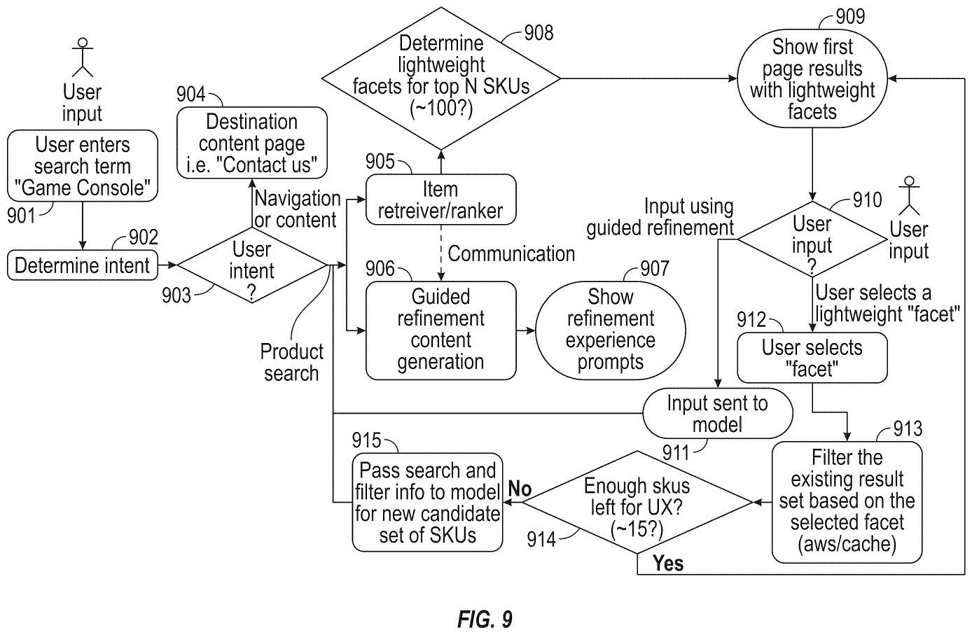

FIG. 9 illustrates an operational schematic for providing generative search functionality in an example e-commerce content service, such as applied in the detailed system configuration 800 discussed above. First, this schematic depicts that a user enters a search term (operation 901), “Game Console”, as an initial operation in the search process. The search term is used to initiate the search workflow with the cloud service 803 and the AI services system 810, as discussed above. The user input is typically received through entry in a user interface, such as a search bar on a website or mobile application, and is then transmitted to the backend system such as the cloud service 803 and the AI services system 810 for processing.

The system determines user intent (operation 902) from the entered terms. This includes analyzing the search term with a large language model, AI model, or natural language processing engine to derive the user's underlying intent of the terms. An evaluation of user intent (evaluation 903) determines an action based on the analysis of the search intent. For instance, some navigation or content, such as navigation to a “Contact us” destination content page (operation 904), is a potential outcome if text such as “Local store phone number” is entered. If the user intent suggests that a product search term is intended, then the system proceeds to search operations.

The search operations use an item retriever/ranker (component 905) for retrieving and ranking search results based on the entered search terms. This component uses the search terms to identify relevant items from a database or catalog. The retriever/ranker functionality employs various search algorithms to assess the relevance of each item based on the user's search query and intent. The items are ranked according to their relevance, ensuring that the most pertinent results are presented. The search operations also use guided refinement content generation (component 906) to create user interface prompts or suggestions, based on the terms, to assist users in refining their search.

For example, based on the search query “Game Console”, the component 905 retrieves and ranks the top N items, such as in one example, up to 100 product SKUs. The system determines lightweight facets for the top N items (evaluation 908) and then outputs a first page or screen of the search results with accompanying facets (operation 909). The search query “Game Console” is also used to determine relevant search refinement prompts that are provided in a refinement prompt display (operation 907).

The refinement experience prompts (operation 907) may be displayed to the user with or adjacent to the search results as part of the search interface, as depicted in the examples of FIG. 3A to FIG. 4, discussed above. These search refinement prompts may offer suggestions or options to refine (e.g., limit, expand, or change) the displayed search results, to improve the process of locating specific items with characteristics of the items that the users are seeking. The refinement experience prompts can also be contextually relevant and personalized based on information other than the search terms, such as derived search intent, preferences, profile information, history, and other user activity.

The system displays initial results to the user in the first page or screen (operation 909) and receives user input (evaluated at evaluation 910). If this user input relates to the selection of a facet (operation 912), then the result set may be filtered based on the selected facet (operation 913). If a threshold number of items remain after filtering by the selected facet (evaluation 914), then the search results may be re-displayed (operation 909). If the threshold number of items does not remain after filtering, then the search and filtering information can be provided to the model to find additional or new items (operation 915). If the user input (evaluated at evaluation 910) relates to the selection of a guided search refinement, then this input is provided to the model (operation 911) and the prompts are applied for additional refinement and item retrieval (with component 905 and component 906).

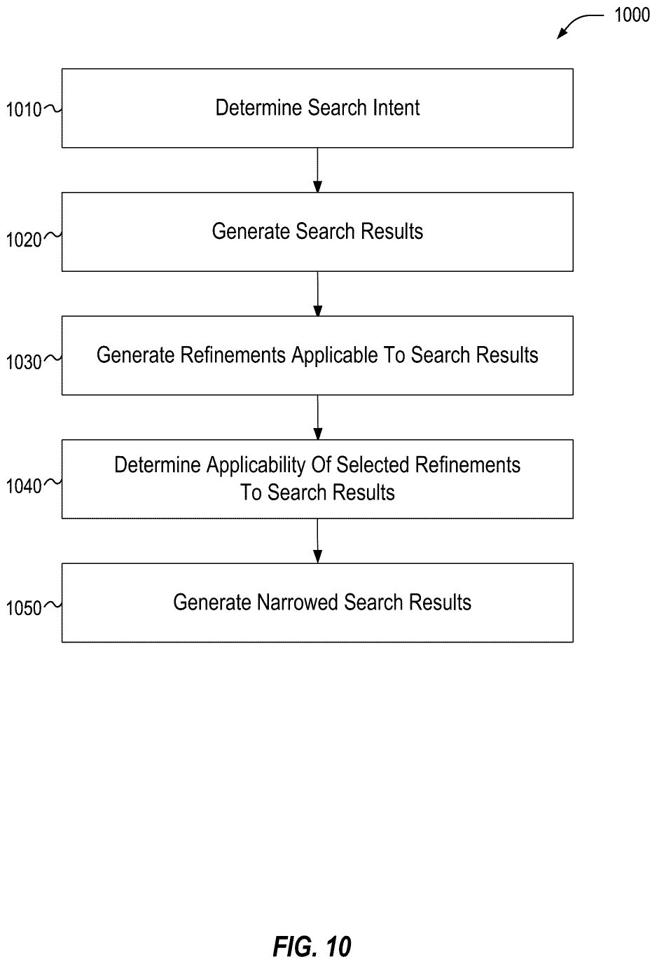

FIG. 10 illustrates a flowchart 1000 of an example workflow for generating refined search results in an e-commerce setting, such as with use of the search engine data processing 720 in FIG. 7, and the search operations depicted in FIG. 8 and FIG. 9 discussed above. Additional or substitute operations may be performed, consistent with the examples above.

The flowchart 1000 begins at operation 1010 with determining a search intent, where the generative search system analyzes natural language input provided by the user to ascertain the underlying intent behind the search query. By understanding the search intent, the generative search system can tailor the subsequent search results and refinements to deliver more precise results and refinement options.

Following the determination of search intent, operation 1020 includes generating search results. In this operation, the generative search system retrieves a set of initial search results based on the interpreted intent and the keywords or phrases provided by the user. These results form the baseline results from which further refinements and enhancements will be made.

Next, operation 1030 includes generating refinements applicable to search results. The system identifies potential refinements that can be applied to the initial search results based on AI models that consider various factors such as item information, contextual information, user preferences, and historical data. These search refinements provide options that can be selectively invoked by a user to narrow down, expand, or change the search results to better match the user's intent and review of items.

Next, operation 1040 includes determining the applicability of selected refinements to search results, such as by evaluating the relevance of the generated refinements to the current search results as different user actions are taken. The generative search system assesses, on an ongoing basis, which refinements are most suitable for further enhancing the search results, as the number, type, and composition of the search refinements changes over time.

Finally, operation 1050 includes generating narrowed search results based on applying the selected refinements. The generative search system applies the selected refinements to output a refined set of search results which typically includes a narrowed set of results (e.g., fewer results than originally appearing in the original search query). These narrowed results are presented to the user, offering a more focused and relevant selection of items that align with the user's search intent.

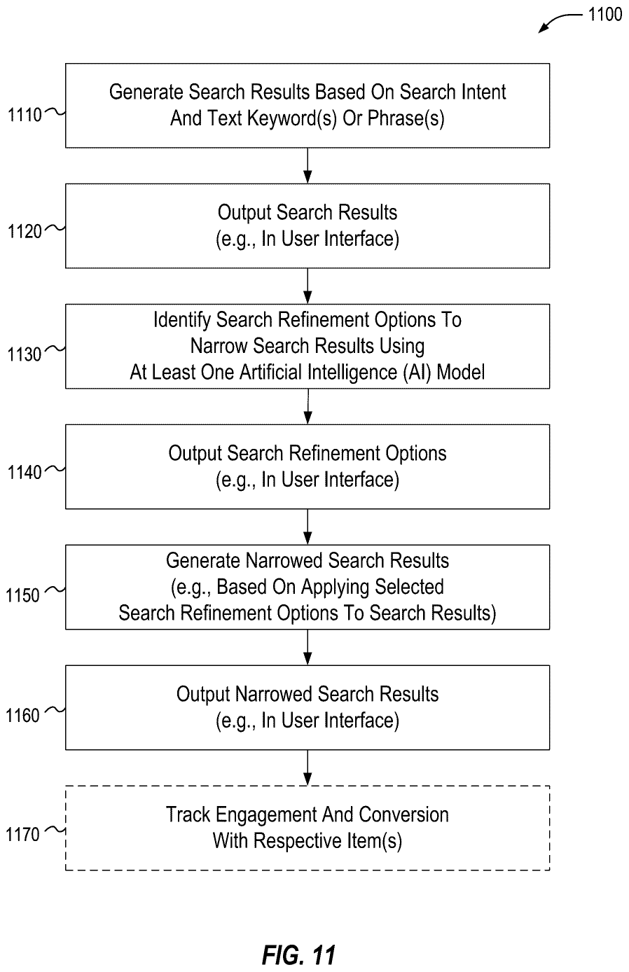

FIG. 11 illustrates a flowchart 1100 of an example method for performing a refined search assisted by generative content. As shown, the flowchart 1100 begins with operation 1110 to generate search results, and operation 1120 to output the search results (e.g., in a user interface). The search results may be generated based on search intent and text keyword(s) or phrase(s), such as at least one keyword or phrase received from a user search input. The search intent can be determined or inferred from the at least one keyword or phrase, and the resulting search results can be identified and ranked based on the search intent and the at least one keyword or phrase. In some examples, as part of determining the search intent, a structured search query may be generated from the at least one keyword or phrase. Additionally, the search intent may be determined by analyzing the natural language understanding of the at least one keyword or phrase with a large language model.

The flowchart 1100 continues with operation 1130 to identify search refinement options to narrow search results using at least one artificial intelligence (AI) model, and operation 1140 to output the search refinement options (e.g., in the user interface). In an example, the at least one AI model includes a predictive model that generates the search refinement options based on patterns or trends occurring in user data associated with the user activity. In another example, the at least one AI model includes a generative large language model that generates the search refinement options by predicting additional search text based on the at least one keyword or phrase.

As discussed above, the search refinement options can include generated search content grouped into feature suggestion prompts, social prompts, or precision search prompts. For instance, for feature suggestion prompts, the at least one AI model can generate the feature suggestion prompts based on one or more features associated with respective items included in the search results. For social prompts, the at least one AI model can generate the social prompts based on activities of other users that are associated with respective items included in the search results. For precision search prompts, the at least one AI model can generate the precision search prompts based on distinguishing attributes of respective items included in the search results.

The flowchart 1100 continues with operation 1150 to generate narrowed search results (e.g., based on applying selected search refinement options to search results), and operation 1160 to output these narrowed search results (e.g., in the user interface). In some examples, the search refinement options and/or the narrowed search results are generated based on narrative text entered in the user interface. For instance, the at least one AI model can evaluate the narrative text to determine the search intent and the at least one keyword or phrase used for identifying the search refinement options.

The flowchart 1100 concludes with optional operation 1170 to track engagement and conversion with the respective item(s). For example, engagement may be tracked with respective items provided in the narrowed search results, such as to track engagement from at least one user action performed with the respective items in the user interface. As another example, conversion may be tracked with a selected item provided in the narrowed search results, such as to track conversion from an electronic commerce transaction performed with the selected item in the user interface. Changes can be provided to the at least one AI model based on engagement and/or conversion of the respective items in the narrowed search results.

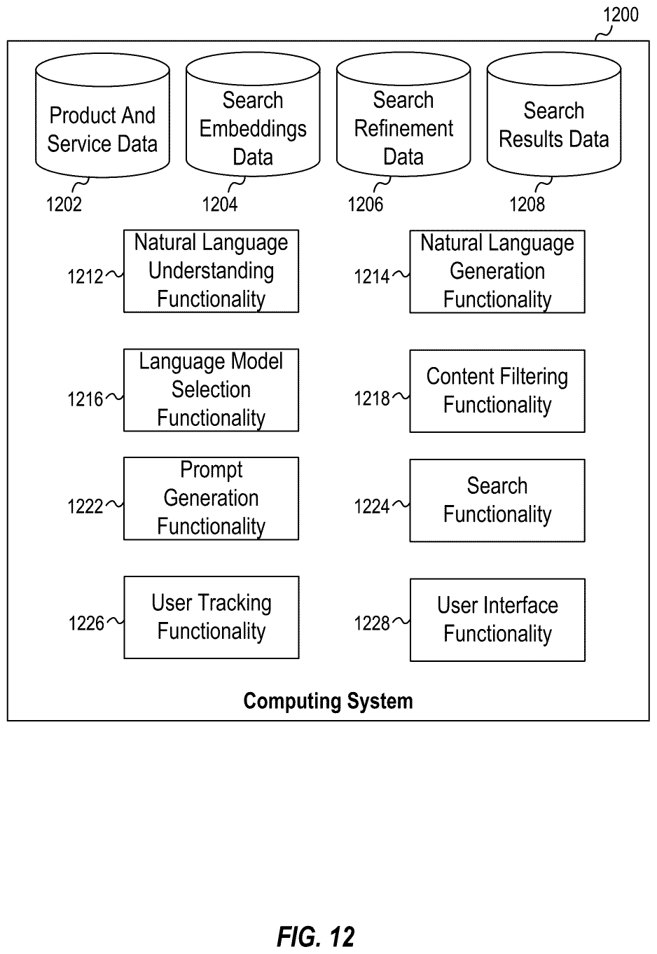

FIG. 12 illustrates a block diagram of hardware and functional components of a computing system 1200 to implement the content service 110, and to perform the search examples and functionality described above. It will be understood, that although certain hardware and functional components are depicted in FIG. 12 and in other drawings as separate subsystems or services, the features of the subsystems or services may be integrated into a single or combined system or service (e.g., accessible via an application programming interfaces hosted by a server computing system, or in a software package executable by a computing device). Further, although only one computing system is depicted, it will be understood that the features of these systems may be distributed among one or multiple computing systems, including in cloud-based or other distributed computing processing settings.

As shown, the computing system 1200 includes various subsystems 1212-1228 used to implement functionality for generative user interface prompt-assisted searches (e.g., to provide the workflows depicted in FIG. 2, operate the user interfaces of FIG. 3A to FIG. 4, facilitate the operations of FIGS. 5, 6, 10, and 11, and implement the components of FIGS. 7, 8, and 9). The computing system 1200 also includes data stores (e.g., databases) of data 1202-1208 to store and access data associated with the content service 110 and the resulting search results and functionality.

The data maintained in the computing system 1200 for enabling generative user interface prompt-assisted searches may include the following. First, product and service data 1202 can be maintained to store particular characteristics and properties of discrete items, including but not limited to features and technical specifications, product reviews, social activity such as user reviews associated with an item, pricing information, etc. Second, the search embeddings data 1204 can be maintained to store representations of relevant data to be analyzed and used by a large language model. Third, the search refinement data 1206 can be maintained to store and track applicable search refinements that are applied to particular search queries and search results. Fourth, the search results data 1208 can be maintained to store and track search result listings, including user interaction with individual items in the search results.

In an example, the computing system 1200 is adapted to execute respective software applications that implement the functionality subsystems and databases through multiple processing components and functionality, such as via circuitry and software instructions. In an example, the computing system 1200 is adapted to implement respective functional components including: natural language understanding functionality 1212 operable to interpret the intent of natural language text, using an LLM or another AI model; and natural language generation functionality 1214 operable to generate or produce text, using an LLM or another AI model. In some examples, separating the natural language understanding from natural language generation tasks assists with workflows for intent detection based on user questions and responses. The computing system 1200 can be adapted to engage the natural language generation functionality 1214 after the search intent is understood and the search action is identified as a supported context. This can help ensure that generated responses are within a contextual boundary while reducing the chance of LLM hallucination.

The computing system also includes language model selection functionality 1216, which provides capabilities to combine the use of LLMs with smaller AI models. For example, instead of sending every user query or question directly to an LLM, the language model selection functionality 1216 may invoke a smaller model to detect what the user is looking for. The query can also be placed into a structured format with another AI model, to be matched with relevant results (products or services).

The computing system also includes content filtering functionality 1218, which can be used to replace or augment static search result filtering with dynamic prompt-based search result filtering from user interface prompts and other generated search refinement options. This enables dynamic user interface prompts to be presented and applied directly into the context of a user's search and matching search results.

The computing system also includes prompt generation functionality 1222, which can be used to generate and group user interface prompts into distinct groups. As noted above, user interface prompts can be separated into three types: social prompts, feature prompts, and precision prompts.

The computing system 1200 also includes search functionality 1224, which can be used to coordinate the generative search and refinement operations as discussed above (e.g., as detailed in the schematics of FIG. 7 to FIG. 9). The search functionality 1224 may be divided into multiple subsystems and coordinated with multiple types of caches, as discussed above.

The computing system 1200 also includes user tracking functionality 1226, which can provide adaptive tracking and measurement based on the results of the generative search. For example, the user tracking functionality 1226 can be used to adapt to characteristics tracked for both engagement and conversion, while collecting data relevant to retraining and improving models accordingly. In addition, the user tracking functionality 1226 can determine changes to be made to an AI model on account of findings from testing and measurement.

The computing system 1200 also includes user interface functionality 1228, used to generate and customize various user interface outputs and receive user interface inputs, relating to the presentation of content and user interaction. Examples of such user interfaces include those discussed above with reference to FIGS. 3A to 4 and other user interface functionality discussed above.

Embodiments used to facilitate and perform the techniques described herein may be implemented in one or a combination of hardware, firmware, or software. Embodiments may also be implemented as instructions stored on a machine-readable storage medium (e.g., a storage device), which may be read and executed by at least one processor to perform the operations described herein. A machine-readable storage medium may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

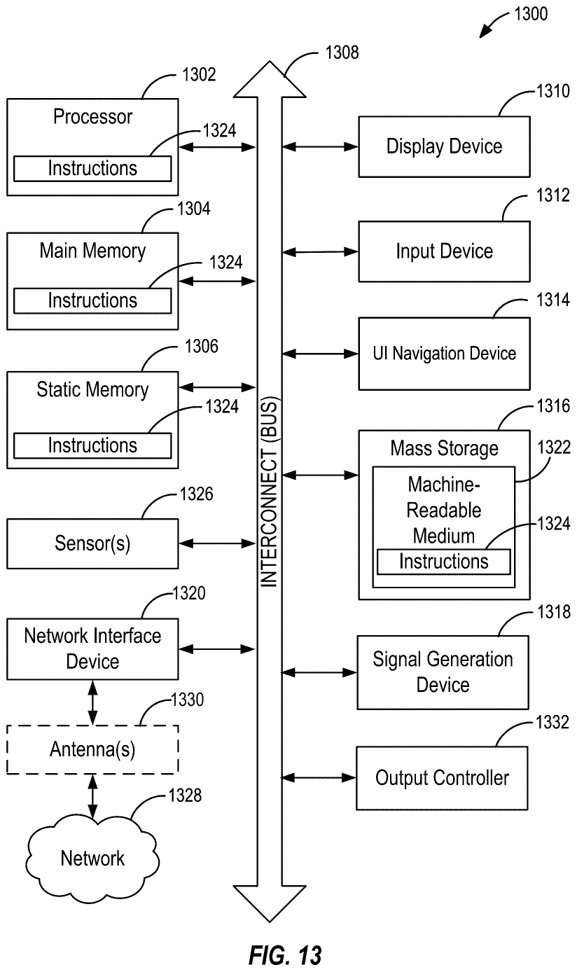

FIG. 13 illustrates a block diagram illustrating a machine in the example form of a computer system machine 1300, within which a set or sequence of instructions may be executed to cause the machine to perform any one of the methodologies discussed herein, according to an example. Computer system machine 1300 may be embodied by the computing system 1200; the subsystem(s) implementing the data stores for data 1202, 1204, 1206, 1208; the subsystem(s) implementing the various components or functionality 1212, 1214, 1216, 1218, 1222, 1224, 1226, 1228; the subsystem(s) implementing the content service 110, cloud service 803, AI services systems 809 or 810, or data processing 720; the computing devices such as mobile device 123, personal computing device 124, mobile device 125, or user device 802; the device or system implementing the user interfaces 301, 360, 400, 710; or any other electronic processing or computing platform described or referred to herein. Further, the computer system machine 1300 may embody instructions and data to perform any of the interfaces or functions referenced for FIGS. 1-12.

Example computer system machine 1300 includes at least one processor 1302 (e.g., a central processing unit (CPU), a graphics processing unit (GPU) or both, processor cores, compute nodes, etc.), a main memory 1304 and a static memory 1306, which communicate with each other via an interconnect 1308 (e.g., a link, a bus, etc.). The computer system machine 1300 may further include a video display unit 1310, an alphanumeric input device 1312 (e.g., a keyboard), and a user interface (UI) navigation device 1314 (e.g., a mouse). In one example, the video display unit 1310, input device 1312 and UI navigation device 1314 are incorporated into a touchscreen interface and touchscreen display. The computer system machine 1300 may additionally include a storage device 1316 (e.g., a drive unit), a signal generation device 1318 (e.g., a speaker), an output controller 1332, a network interface device 1320 (which may include or operably communicate with one or more antennas 1330, transceivers, or other wireless communications hardware), and one or more sensors 1326, such as a global positioning system (GPS) sensor, compass, accelerometer, location sensor, or other sensor.

The storage device 1316 includes a machine-readable medium 1322 on which is stored one or more sets of data structures and instructions 1324 (e.g., software) embodying or utilized by any one or more of the methodologies or functions described herein. The instructions 1324 may also reside, completely or at least partially, within the main memory 1304, static memory 1306, and/or within the processor 1302 during execution thereof by the computer system machine 1300, with the main memory 1304, static memory 1306, and the processor 1302 also constituting machine-readable media.

While the machine-readable medium 1322 is illustrated in an example to be a single medium, the term “machine-readable medium” may include a single medium or multiple media (e.g., a centralized or distributed database, and/or associated caches and servers) that store the one or more instructions 1324. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 1324 may further be transmitted or received over a communications network 1328 using a transmission medium via the network interface device 1320 utilizing any one of a number of well-known transfer protocols (e.g., HTTP). Examples of communication networks include a local area network (LAN), a wide area network (WAN), the Internet, mobile and wired telephone networks, and wireless data networks (e.g., Wi-Fi, 3G, 4G LTE/LTE-A, 5G, or Satellite communication networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method for presenting search results in a user interface, the method comprising operations executed using at least one processor of a computing device, and the operations comprising: receiving a search query in the user interface, the search query including at least one keyword or phrase; retrieving search results based on the search query, the search results including multiple items; identifying additional search refinements capable of being selectively applied to the search results, the additional search refinements generated by at least one artificial intelligence (AI) model; presenting the additional search refinements in the user interface; receiving a selection in the user interface of one or more of the additional search refinements; creating an updated search query based on the selection of the additional search refinements; retrieving updated search results produced by refining the search results, based on the updated search query; and presenting the updated search results in the user interface, the updated search results including a re-ordered set or a reduced set of the items included in the search results.

In Example 2, the subject matter of Example 1 optionally includes wherein the additional search refinements include feature suggestion prompts, and wherein the at least one AI model generates the feature suggestion prompts based on one or more features associated with the items included in the search results.

In Example 3, the subject matter of any one or more of Examples 1-2 optionally include wherein the additional search refinements include social prompts, and wherein the at least one AI model generates the social prompts based on activities of other users that are associated with the items included in the search results.

In Example 4, the subject matter of any one or more of Examples 1-3 optionally include wherein the additional search refinements include precision search prompts, and wherein the at least one AI model generates the precision search prompts based on distinguishing attributes of the items included in the search results.

In Example 5, the subject matter of any one or more of Examples 1-4 optionally include wherein the additional search refinements include one or more sponsored prompts, and wherein the one or more sponsored prompts are selected based on at least one keyword or phrase generated by the at least one AI model and associated with the one or more sponsored prompts.

In Example 6, the subject matter of any one or more of Examples 1-5 optionally include wherein the additional search refinements are generated based on narrative text entered in the user interface, and wherein the at least one AI model evaluates the narrative text to determine relevance to the items included in the search results.

In Example 7, the subject matter of any one or more of Examples 1-6 optionally include wherein the additional search refinements include search query suggestions generated by the at least one AI model, and wherein the search query suggestions are presented in the user interface based in part on user interactions with the multiple items.

In Example 8, the subject matter of any one or more of Examples 1-7 optionally include wherein the additional search refinements include search query suggestions generated by the at least one AI model, wherein the search query suggestions are selected for presentation based in part on sponsorship of one or more associated items.

In Example 9, the subject matter of any one or more of Examples 1-8 optionally include presenting a set of facets in the user interface, the set of facets applicable to the updated search results; receiving a user selection of the set of facets in the user interface, to further refine the updated search results based on the updated search query; and presenting a refinement to the updated search results in the user interface, based on the user selection of the set of facets.

In Example 10, the subject matter of any one or more of Examples 1-9 optionally include wherein the updated search query is a structured query that is generated from the search query and the selection of the one or more of the additional search refinements, and wherein the selection of the one or more of the additional search refinements is indicated in the user interface.

In Example 11, the subject matter of any one or more of Examples 1-10 optionally include wherein the multiple items include products or services or combinations thereof, and wherein placement of a respective item of the multiple items is determined within the updated search results based on at least one of: sponsorship of the respective item, user ratings associated with the respective item, or user interaction associated with the respective item.

In Example 12, the subject matter of any one or more of Examples 1-11 optionally include wherein the at least one AI model includes a predictive model, and wherein the predictive model generates the additional search refinements based on patterns or trends occurring in user data associated with the user interface.

In Example 13, the subject matter of any one or more of Examples 1-12 optionally include wherein the at least one AI model includes a generative large language model, and wherein the generative large language model generates the additional search refinements by predicting additional search keywords based on the search query.

Example 14 is a non-transitory computer-readable storage medium, the computer-readable storage medium comprising instructions that, when executed by processor circuitry and memory of a computing device, causes the computing device to present search results in a user interface, with operations that: receive a search query in the user interface, the search query including at least one keyword or phrase; retrieve search results based on the search query, the search results including multiple items; identify additional search refinements capable of being selectively applied to the search results, the additional search refinements generated by at least one artificial intelligence (AI) model; output data to present the additional search refinements in the user interface; receive a selection in the user interface of one or more of the additional search refinements; create an updated search query based on the selection of the additional search refinements; retrieve updated search results produced by refining the search results, based on the updated search query; and present the updated search results in the user interface, the updated search results including a re-ordered set or a reduced set of the items included in the search results.

In Example 15, the subject matter of Example 14 optionally includes wherein the additional search refinements include one or more of: feature suggestion prompts, wherein the at least one AI model generates the feature suggestion prompts based on one or more features associated with the items included in the search results; social prompts, and wherein the at least one AI model generates the social prompts based on activities of other users that are associated with the items included in the search results; or precision search prompts, and wherein the at least one AI model generates the precision search prompts based on distinguishing attributes of the items included in the search results.

In Example 16, the subject matter of any one or more of Examples 14-15 optionally include wherein the additional search refinements include one or more sponsored prompts, and wherein the one or more sponsored prompts are selected based on at least one keyword or phrase generated by the at least one AI model and associated with the one or more sponsored prompts

In Example 17, the subject matter of any one or more of Examples 14-16 optionally include wherein the additional search refinements are generated based on narrative text entered in the user interface, and wherein the at least one AI model evaluates the narrative text to determine relevance to the items included in the search results.

In Example 18, the subject matter of any one or more of Examples 14-17 optionally include wherein the additional search refinements include search query suggestions generated by the at least one AI model, wherein the search query suggestions are selected for presentation based in part on: user interactions with the multiple items; or sponsorship of one or more associated items.

In Example 19, the subject matter of any one or more of Examples 14-18 optionally include wherein the instructions further cause the computing device perform operations that: present a set of facets in the user interface, the set of facets applicable to the updated search results; receive a user selection of the set of facets in the user interface, to further refine the updated search results based on the updated search query; and present a refinement to the updated search results in the user interface, based on the user selection of the set of facets.

In Example 20, the subject matter of any one or more of Examples 14-19 optionally include wherein the updated search query is a structured query that is generated from the search query and the selection of the one or more of the additional search refinements, and wherein the selection of the one or more of the additional search refinements is indicated in the user interface.

In Example 21, the subject matter of any one or more of Examples 14-20 optionally include wherein the multiple items include products or services or combinations thereof, and wherein placement of a respective item of the multiple items is determined within the updated search results based on at least one of: sponsorship of the respective item, user ratings associated with the respective item, or user interaction associated with the respective item.

In Example 22, the subject matter of any one or more of Examples 14-21 optionally include wherein the at least one AI model includes at least one of: a predictive model, wherein the predictive model generates the additional search refinements based on patterns or trends occurring in user data associated with the user interface; or a generative large language model, wherein the generative large language model generates the additional search refinements by predicting additional search keywords based on the search query.

Example 23 is a method for performing search assisted by generative content, the method comprising operations executed using at least one processor of a computing device, and the operations comprising: receiving text that includes at least one keyword or phrase; determining a search intent from the at least one keyword or phrase; generating search results based on the search intent and the at least one keyword or phrase; outputting the search results to be presented in a user interface; identifying search refinement options to narrow the search results using at least one artificial intelligence (AI) model, wherein the at least one AI model produces the search refinement options from inputs including (i) the at least one keyword or phrase, (ii) the search intent, and (iii) user activity; outputting the search refinement options to be presented in the user interface; receiving one or more of the search refinement options as selected refinement options; generating narrowed search results based on applying the selected refinement options to the search results; and outputting the narrowed search results to be presented in the user interface.

In Example 24, the subject matter of Example 23 optionally includes wherein the at least one AI model includes a predictive model, and wherein the predictive model generates the search refinement options based on patterns or trends occurring in user data associated with the user activity.

In Example 25, the subject matter of any one or more of Examples 23-24 optionally include wherein the at least one AI model includes a generative large language model, and wherein the generative large language model generates the search refinement options by predicting additional search text based on the at least one keyword or phrase.

In Example 26, the subject matter of any one or more of Examples 23-25 optionally include wherein determining the search intent includes performing natural language understanding of the at least one keyword or phrase with a large language model.

In Example 27, the subject matter of Example 26 optionally includes wherein determining the search intent further includes generating a structured search query from the at least one keyword or phrase, and wherein the search results are generated based on the structured search query.

In Example 28, the subject matter of any one or more of Examples 23-27 optionally include wherein the search refinement options include generated search content grouped into feature suggestion prompts, social prompts, or precision search prompts.

In Example 29, the subject matter of any one or more of Examples 23-28 optionally include wherein the search refinement options include feature suggestion prompts, and wherein the at least one AI model generates the feature suggestion prompts based on one or more features associated with respective items included in the search results.

In Example 30, the subject matter of any one or more of Examples 23-29 optionally include wherein the search refinement options include social prompts, and wherein the at least one AI model generates the social prompts based on activities of other users that are associated with respective items included in the search results.

In Example 31, the subject matter of any one or more of Examples 23-30 optionally include wherein the search refinement options include precision search prompts, and wherein the at least one AI model generates the precision search prompts based on distinguishing attributes of respective items included in the search results.

In Example 32, the subject matter of any one or more of Examples 23-31 optionally include identifying additional search refinement options to narrow the search results that include one or more sponsored prompts, wherein the one or more sponsored prompts are selected based on at least one keyword or phrase generated by the at least one AI model or associated with the one or more sponsored prompts; and outputting the one or more sponsored prompts to be presented in the user interface; wherein receiving a selection of the one or more sponsored prompts as the selected refinement options causes the narrowed search results to be presented based on sponsorship of respective items in the narrowed search results.

In Example 33, the subject matter of any one or more of Examples 23-32 optionally include wherein the search refinement options are generated based on narrative text entered in the user interface, and wherein the at least one AI model evaluates the narrative text to determine the search intent and the at least one keyword or phrase used for identifying the search refinement options.

In Example 34, the subject matter of Example 33 optionally includes tracking engagement with respective items in the narrowed search results, wherein the engagement includes at least one user action performed with the respective items in the user interface; and providing changes to the at least one AI model based on engagement with the respective items in the narrowed search results.

In Example 35, the subject matter of Example 34 optionally includes tracking conversion for a selected item in the narrowed search results, wherein the conversion includes an electronic commerce transaction performed with the selected item; and providing changes to the at least one AI model based on the conversion for a selected item in the narrowed search results in the narrowed search results.

Example 36 is a non-transitory computer-readable storage medium, the computer-readable storage medium comprising instructions that, when executed by processor circuitry and memory of a computing device, causes the computing device to provide search results via a user interface, with operations that: receive text that includes at least one keyword or phrase; determine a search intent from the at least one keyword or phrase; generate search results based on the search intent and the at least one keyword or phrase; output the search results to be presented in a user interface; identify search refinement options to narrow the search results using at least one artificial intelligence (AI) model, wherein the at least one AI model produces the search refinement options from inputs including (i) the at least one keyword or phrase, (ii) the search intent, and (iii) user activity; output the search refinement options to be presented in the user interface; receive one or more of the search refinement options as selected refinement options; generate narrowed search results based on applying the selected refinement options to the search results; and output the narrowed search results to be presented in the user interface.

In Example 37, the subject matter of Example 36 optionally includes wherein the at least one AI model includes a predictive model that generates the search refinement options based on patterns or trends occurring in user data associated with the user activity.

In Example 38, the subject matter of any one or more of Examples 36-37 optionally include wherein the at least one AI model includes a generative large language model that generates the search refinement options by predicting additional search text based on the at least one keyword or phrase.

In Example 39, the subject matter of any one or more of Examples 36-38 optionally include wherein determining the search intent includes performing natural language understanding of the at least one keyword or phrase with a large language model, and generating a structured search query from the at least one keyword or phrase, wherein the search results are generated based on the structured search query.

In Example 40, the subject matter of any one or more of Examples 36-39 optionally include wherein the search refinement options include generated search content grouped into at least one of: feature suggestion prompts, wherein the at least one AI model generates the feature suggestion prompts based on one or more features associated with respective items included in the search results; social prompts, wherein the at least one AI model generates the social prompts based on activities of other users that are associated with respective items included in the search results; or precision search prompts, wherein the at least one AI model generates the precision search prompts based on distinguishing attributes of respective items included in the search results.

In Example 41, the subject matter of any one or more of Examples 36-40 optionally include wherein the search refinement options are generated based on narrative text entered in the user interface, and wherein the at least one AI model evaluates the narrative text to determine the search intent and the at least one keyword or phrase used for identifying the search refinement options.

In Example 42, the subject matter of any one or more of Examples 36-41 optionally include wherein the instructions further cause the computing device to perform operations that: identify additional search refinement options to narrow the search results with one or more sponsored prompts, wherein the one or more sponsored prompts are selected based on at least one keyword or phrase generated by the at least one AI model or associated with the one or more sponsored prompts; and output the one or more sponsored prompts to be presented in the user interface; wherein receiving a selection of the one or more sponsored prompts as the selected refinement options causes the narrowed search results to be presented based on sponsorship of respective items in the narrowed search results.

In Example 43, the subject matter of any one or more of Examples 36-42 optionally include wherein the instructions further cause the computing device to perform operations that: track engagement with respective items in the narrowed search results, wherein the engagement includes at least one user action performed with the respective items in the user interface; and change the at least one AI model based on engagement with the respective items in the narrowed search results.

In Example 44, the subject matter of any one or more of Examples 36-43 optionally include wherein the instructions further cause the computing device to perform operations that: track conversion for a selected item in the narrowed search results, wherein the conversion includes an electronic commerce transaction performed with the selected item; and change the at least one AI model based on the conversion for a selected item in the narrowed search results in the narrowed search results.

Example 45 is a non-transitory computer-readable storage medium, the computer-readable storage medium comprising instructions that, when executed by processor circuitry and memory of a computing device, causes the computing device to perform the operations of any of Examples 1 to 44.

Example 46 is a computing device comprising a hardware processor and a memory, the memory storing instructions, which when executed by the hardware processor, cause the computing device to perform the operations of any of Examples 1 to 44.

Example 47 is a computing system comprising means to perform the operations of any of Examples 1 to 44.

Example 48 is an apparatus comprising means to implement of any of Examples 1 to 47.

Example 49 is a system to implement of any of Examples 1 to 47.

Additional examples of the presently described method, system, and device embodiments include the following configurations recited by the claims. Each of the examples in the claims may stand on its own, or may be combined in any permutation or combination with any one or more of the other examples provided below or throughout the present disclosure.

1. A method for performing a refined search assisted by generative content, the method comprising operations executed using at least one processor of a computing device, and the operations comprising:
receiving text that includes at least one keyword or phrase;
determining a search intent from the at least one keyword or phrase;
generating search results based on the search intent and the at least one keyword or phrase;
outputting the search results to be presented in a user interface;
identifying search refinement options to narrow the search results using at least one artificial intelligence (AI) model,
wherein the at least one AI model produces the search refinement options from multiple inputs including (i) the at least one keyword or phrase, (ii) the search intent, and (iii) user activity,
wherein the at least one AI model includes a generative large language model that generates at least some of the search refinement options by predicting additional search text using the at least one keyword or phrase and the search intent, and
wherein the at least one AI model includes a predictive model that generates at least some of the search refinement options using the user activity;
outputting the search refinement options to be concurrently presented in the user interface with the search results;
receiving one or more of the search refinement options in the user interface as user-selected refinement options;
generating narrowed search results based on applying the user-selected refinement options to the search results; and
outputting the narrowed search results to be presented in the user interface.

2. The method of claim 1, wherein the predictive model personalizes at least some of the search refinement options based on patterns or trends occurring in user data associated with the user activity.

3. (canceled)

4. The method of claim 1, wherein determining the search intent includes performing natural language understanding of the at least one keyword or phrase with a large language model.

5. The method of claim 4, wherein determining the search intent further includes generating a structured search query from the at least one keyword or phrase, and wherein the search results are generated based on the structured search query.

6. The method of claim 1, wherein the search refinement options include generated search content grouped into feature suggestion prompts, social prompts, or precision search prompts.

7. The method of claim 1, wherein the search refinement options include feature suggestion prompts, and wherein the at least one AI model generates the feature suggestion prompts based on one or more features associated with respective items included in the search results.

8. The method of claim 1, wherein the search refinement options include social prompts, and wherein the at least one AI model generates the social prompts based on activities of other users that are associated with respective items included in the search results.

9. The method of claim 1, wherein the search refinement options include precision search prompts, and wherein the at least one AI model generates the precision search prompts based on distinguishing attributes of respective items included in the search results.

10. The method of claim 1, further comprising:
identifying additional search refinement options to narrow the search results that include one or more sponsored prompts, wherein the one or more sponsored prompts are selected based on at least one keyword or phrase generated by the at least one AI model or associated with the one or more sponsored prompts; and
outputting the one or more sponsored prompts to be presented in the user interface;
wherein receiving a selection of the one or more sponsored prompts as the selected refinement options causes the narrowed search results to be presented based on sponsorship of respective items in the narrowed search results.

11. The method of claim 1, wherein the search refinement options are generated based on narrative text entered in the user interface, and wherein the at least one AI model evaluates the narrative text to determine the search intent and the at least one keyword or phrase used for identifying the search refinement options.

12. The method of claim 11, further comprising:
tracking engagement with respective items in the narrowed search results, wherein the engagement includes at least one user action performed with the respective items in the user interface; and
providing changes to the at least one AI model based on engagement with the respective items in the narrowed search results.

13. The method of claim 12, further comprising:
tracking conversion for a selected item in the narrowed search results, wherein the conversion includes an electronic commerce transaction performed with the selected item; and
providing changes to the at least one AI model based on the conversion for a selected item in the narrowed search results.

14. A non-transitory computer-readable storage medium, the computer-readable storage medium comprising instructions that, when executed by processor circuitry and memory of a computing device, causes the computing device to provide refined search results via a user interface, with operations that:
receive text that includes at least one keyword or phrase;
determine a search intent from the at least one keyword or phrase;
generate search results based on the search intent and the at least one keyword or phrase;
output the search results to be presented in a user interface;
identify search refinement options to narrow the search results using at least one artificial intelligence (AI) model,
wherein the at least one AI model produces the search refinement options from multiple inputs including (i) the at least one keyword or phrase, (ii) the search intent, and (iii) user activity,
wherein the at least one AI model includes a generative large language model that generates at least some of the search refinement options by predicting additional search text using the at least one keyword or phrase and the search intent, and
wherein the at least one AI model includes a predictive model that generates at least some of the search refinement options using the user activity;
output the search refinement options to be concurrently presented in the user interface with the search results;
receive one or more of the search refinement options in the user interface as user-selected refinement options;
generate narrowed search results based on applying the user-selected refinement options to the search results; and
output the narrowed search results to be presented in the user interface.

15. The non-transitory computer-readable storage medium of claim 14, wherein the predictive model personalizes at least some of the search refinement options based on patterns or trends occurring in user data associated with the user activity.

16. (canceled)

17. The non-transitory computer-readable storage medium of claim 14, wherein determining the search intent includes performing natural language understanding of the at least one keyword or phrase with a large language model, and generating a structured search query from the at least one keyword or phrase, wherein the search results are generated based on the structured search query.

18. The non-transitory computer-readable storage medium of claim 14, wherein the search refinement options include generated search content grouped into at least one of:
feature suggestion prompts, wherein the at least one AI model generates the feature suggestion prompts based on one or more features associated with respective items included in the search results;
social prompts, wherein the at least one AI model generates the social prompts based on activities of other users that are associated with respective items included in the search results; or precision search prompts, wherein the at least one AI model generates the precision search prompts based on distinguishing attributes of respective items included in the search results.

19. The non-transitory computer-readable storage medium of claim 14, wherein the search refinement options are generated based on narrative text entered in the user interface, and wherein the at least one AI model evaluates the narrative text to determine the search intent and the at least one keyword or phrase used for identifying the search refinement options.

20. The non-transitory computer-readable storage medium of claim 14, wherein the instructions further cause the computing device to perform operations that:
identify additional search refinement options to narrow the search results with one or more sponsored prompts, wherein the one or more sponsored prompts are selected based on at least one keyword or phrase generated by the at least one AI model or associated with the one or more sponsored prompts; and
output the one or more sponsored prompts to be presented in the user interface;
wherein receiving a selection of the one or more sponsored prompts as the selected refinement options causes the narrowed search results to be presented based on sponsorship of respective items in the narrowed search results.

21. The non-transitory computer-readable storage medium of claim 14, wherein the instructions further cause the computing device to perform operations that:
track engagement with respective items in the narrowed search results, wherein the engagement includes at least one user action performed with the respective items in the user interface; and
change the at least one AI model based on engagement with the respective items in the narrowed search results.

22. The non-transitory computer-readable storage medium of claim 14, wherein the instructions further cause the computing device to perform operations that:
track conversion for a selected item in the narrowed search results, wherein the conversion includes an electronic commerce transaction performed with the selected item; and
change the at least one AI model based on the conversion for a selected item in the narrowed search results.
